(19) United States
(12) Patent Application Publication
(10) Pub. No.: US 2005/0206948 A1
(43) Pub. Date: Sep. 22, 2005

(54) Image formation assistance device, image formation assistance method and image formation assistance system

(75) Inventor: Hiroyoshi Uejo, Ebina-shi (JP)

Correspondence Address: OLIFF & BERRIDGE, PLC, P.O. BOX 19928, ALEXANDRIA, VA, 22320, US

(73) Assignee: FUJI XEROX CO., LTD., Minato-ku (JP)

(21) Appl. No.: 10/965,822

(22) Filed: Oct. 18, 2004

(30) Foreign Application Priority Data
Mar. 16, 2004 (JP) 2004-74615
Mar. 16, 2004 (JP) 2004-74616

(51) Int. Cl. G06F 15/00

(52) U.S. Cl. 358/1.15

(57) ABSTRACT

The present invention provides an image formation assistance device that processes image data including a memory that retains image data created for a printing plate, a line image determination unit that determines a character/line image portion in the image data stored in the memory, and a gradation converter that conducts gradation conversion processing that converts gradation of the image data from a low gradation to a high gradation on the basis of a determination result of the line image determination unit, that can use image data for CTP in on-demand printing, prevent the deterioration of characters and line images at gradation conversion, and maintain the sharpness of black characters at gradation conversion.

### CROSS-REFERENCE TO RELATED APPLICATION

This application claims priority under 35 USC 119 from Japanese Patent Applications Nos. 2004-74615 and 2004-74616 the disclosures of which are incorporated by reference herein.

### BACKGROUND OF THE INVENTION

1. Field of the Invention

The present invention relates to an image formation assistance device, an image formation assistance method and an image formation assistance system, and in particular to an image formation assistance device, an image formation assistance method and an image formation assistance system that output data to an image forming device having a so-called printing function for forming an image on a recording medium, such as a color copier, a fax machine, a printer or the like.

2. Description of the Related Art

In conventional printing (e.g., offset printing), intermediate products such as exposing-papers in photo-composing and the like (photographic printing papers), art works, halftone negatives and halftone positives are generated, and printing and bookbinding are conducted by a printing plate made on the basis of these intermediate products and from, for example, a PS plate. In recent years, due to the spread of DTP (DeskTop Publishing/Prepress), “direct printing” and “on-demand printing” are known where printing is done directly from DTP data. In DTP, processing is spreading where printing data obtained by processing a page layout on a computer is formed on a photographic printing paper or a photographic film for plate making and printing is done by creating a printing plates on the basis of this. CTP (Computer To Plate), where a direct printing plate is formed by electronic data without generating intermediate products, is also gaining attention. Image forming devices provided with a printing function, such as printers and copiers, are known as devices that can be used in such printing processing. Image quality improvements have risen in image forming devices of recent years, and the image forming devices are being colorized. For example, with color printers using an electrophotographic process (xerography), high-quality and high-speed image formation is possible. These image forming devices receive printing data and can output printed matter without making printing plates.

FIGS. 9A and 9B are configural diagrams of a conventional image forming system. As shown in FIG. 9A, which is a diagram showing the overall configuration, the image forming system is configured by an image forming device 11 and a DFE (Digital Front End Processor) device that delivers printing data to the image forming device 11 and instructs printing. FIG. 9B shows the flow of the data.

The DFE device has a drawing function and a printer controller function. For example, the DFE device sequentially receives printing data described by page description language (PDL) from a client terminal, converts the printing data to a raster image (RIP: Raster Image Process), sends the RIP processed image data and printing control information (job ticket), such as the number of sheets to be printed and the paper size, to the image forming device 11, controls the print engine and paper conveyance system of the image forming device 11, and causes the image forming device 11 to execute printing processing. Namely, the printing operation of the image forming device 11 is controlled by the printer controller by the DFE device. With respect to the printing data, four colors (Y, M, C and K), in which the three colors of yellow (Y), cyan (C) and magenta (M) that are the basic colors for color printing are combined with black (K), are sent to the image forming device 11.

The image forming device 11 records an image on printing paper using an electrophotographic process, and is provided with an IOT (Image Output Terminal) module 12, a feeder module (FM) 5 connected to the IOT module 12, an output module 17, and a user interface device 18 that includes a touch panel and is for assisting input of various data. The IOT module 12 includes a toner supply unit 22, in which Y, M, C and K toner cartridges 24 are mounted, and an IOT core unit 20. The IOT core unit 20 has a so-called tandem configuration where print engines (printing units) 30 including optical scanning devices and photosensitive drums are disposed per color in a row in a belt rotation direction. The IOT core unit 20 is provided with an electrical system control housing 39 that houses electrical circuits that control the print engines 30. The IOT core unit 20 transfers toner images on the photosensitive drums to an intermediate transfer belt 43 (primary transfer) and then transfers the toner images to printing paper (secondary transfer). That is, toner images of the colors of Y, M, C and K are multiply transferred to the intermediate transfer belt 43, the images (toner images) transferred to the intermediate transfer belt 43 are transferred to printing paper conveyed at a predetermined timing from the feeder module 15, and the toner images are fused and fixed to the paper by a fuser 70. Thereafter, the paper is discharged to the outside of the device via a discharge processing device 72. In the case of two-sided printing, paper that has been printed on one side is temporarily retained in a discharge tray (stacker) 74, pulled out from the discharge tray 74, inverted via an inversion conveyance path 49, and again delivered to the IOT core unit 20.

In contrast, in CTP, the above-described RIP processing is conducted by the DFE device. In this case, because CTP usually uses a large-sized printing plate of about 1 m, surface-positioning is conducted and image data where plural images are surface-positioned are generated. Then, a printing plate is formed by the generated image data, printing is conducted, and post-processing such as cutting is conducted.

When image data created for CTP is to be printed by the above-described image forming system, the image data created for CTP has high resolution and low gradation (e.g., 2400 dpi, 1 bit), but they have a low resolution and a high gradation (e.g., 600 dpi, 8 bit) in the image forming system, and for this reason it is necessary to conduct conversion of the resolution and gradation (called descreening processing below).

As the descreening processing, a technique has been proposed where 1 bit is descreened, converted to multiple values and outputted to a printer.

For example, it is known to provide a technique of multiplication by filtering (soft filtering) a binary image. At the time of the filtering, filtering is conducted so as to leave a halftone dot structure.

However, there are the problems that, in a case where 1 bit is descreened simply by filtering and multiplied, small point characters end up becoming submerged and line images end up becoming faint. Moreover, there is the problem that, in cases where there are background colors in black characters, colors spread to adjacent pixels and the sharpness of black characters drops.

### SUMMARY OF THE INVENTION

The present invention is made in consideration of the above-described facts, and provides an image formation assistance device, an image formation assistance method and an image formation assistance system.

The image formation assistance device, the image formation assistance method and the image formation assistance system of the present invention determine a character/line image portion of image data created for a printing plate and convert the image data from a low gradation to a high gradation on the basis of the determination result, whereby they can convert a gradation of image data for CTP to a gradation for on-demand printing and can separately convert the gradation of character/line image portion and other portion, so that they can use image data for CTP in on-demand printing and can prevent the deterioration of the character and the line image at the time of gradation conversion.

A first aspect of the invention provides an image formation assistance device that processes image data includes a memory that retains image data created for a printing plate, a line image determination unit that determines a character/line image portion in the image data stored in the memory, and, a gradation converter that conducts gradation conversion processing that converts gradation of the image data from a low gradation to a high gradation on the basis of a determination result of the line image determination unit.

Also, a second aspect of the invention provides an image formation assistance method that processes image data including retaining image data created for a printing plate (image storing step), determining a character/line image portion in the image data (character/line image determining step), and conducting gradation conversion processing that converts gradation of the image data from a low gradation to a high gradation on the basis of a determination result obtained when determining the character/line image portion (converting step).

As a third aspect of the invention, an image formation assistance system may include the aforementioned image formation assistance device and an image generation device that processes the printing job to generate the image data and outputs the image data to the image formation assistance device.

Moreover, the image formation assistance device of the invention may determine a black character portion after converting gradation of the image data from a low gradation to a high gradation and have the function of conducting image processing in regard to the image data corresponding to the black character portion so that the image data becomes one color of black, whereby the black character can be expressed as one color of black with regard to the image data after gradation conversion when a gradation of the image data for CTP is converted to a gradation printable in on-demand printing.

A fourth aspect of the invention provides an image formation assistance device that processes image data includes a memory that retains image data created for a printing plate, a gradation converter that converts gradation of the image data stored in the memory from a low gradation to a high gradation, a determination unit that determines a black character portion in high-gradation image data obtained by the conversion of the gradation converter, and an image processing unit that conducts image processing, on the basis of a determination result of the determination unit, on image data corresponding to the black character portion so as to be one color of black.

### BRIEF DESCRIPTION OF THE DRAWINGS

Embodiments of the present invention will be described in detail based on the following figures, wherein:

FIG. 1 is a schematic diagram showing the overall configuration of an image forming system pertaining to an embodiment of the invention;

FIGS. 2A and 2B are diagrams showing an embodiment of the image forming system;

FIG. 3 is a block diagram showing an embodiment of a DFE device and a BEP device;

FIG. 4 is a block diagram showing the detailed configuration of the BEP device pertaining to the embodiment of the invention;

FIG. 5 is a block diagram showing the detailed configuration of a video interface of the BEP device pertaining to the embodiment of the invention;

FIG. 6 is a flow chart showing an example of the flow of processing conducted by the video interface;

FIG. 7 is a schematic diagram showing common descreening processing;

FIG. 8 is a diagram showing an example of image data in which there are a character region and a photograph region;

FIGS. 9A and 9B are diagrams showing the outline of a conventional image forming system;

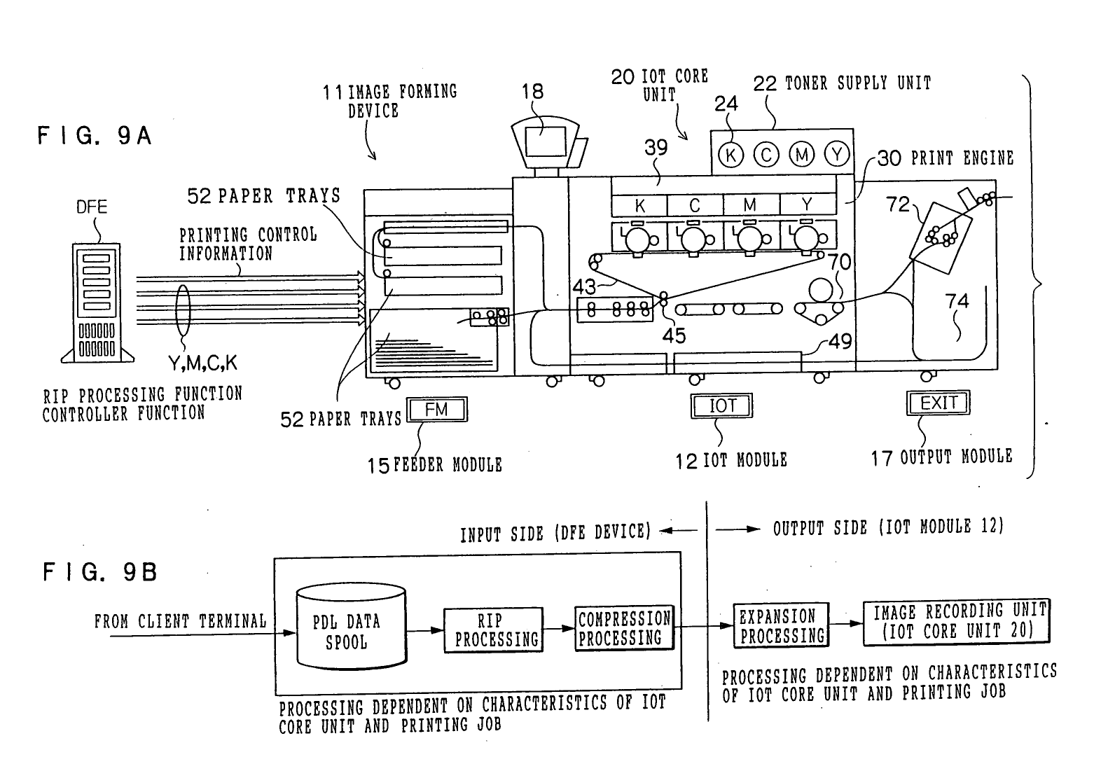

FIG. 10 is a functional block diagram showing the detailed configuration of a modified example of the video interface of the BEP device pertaining to the embodiment of the invention;

FIG. 11 is a flow chart showing an example of the flow of processing conducted by the modified example of the video interface; and

FIG. 12 is a flow chart showing a modified example of the flow of processing conducted by the modified example of the video interface.

### DETAILED DESCRIPTION OF THE INVENTION

An example of an embodiment of the invention will be described in detail below with reference to the drawings.

Image Forming System

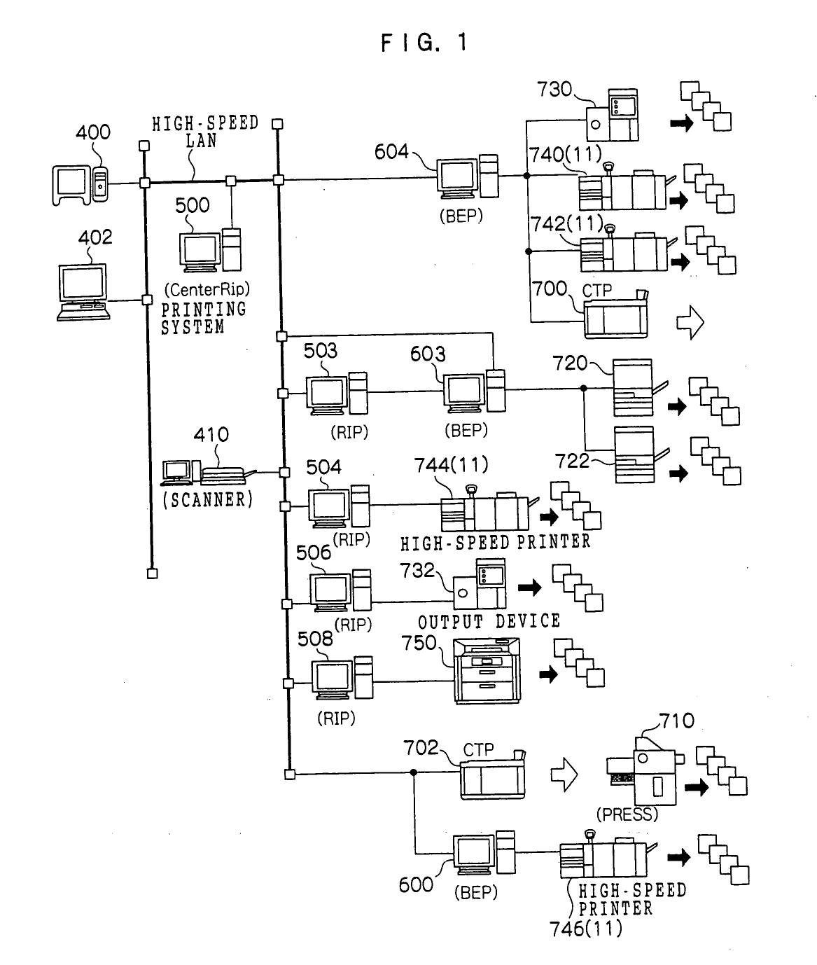

FIG. 1 is a diagram showing the overall schematic configuration of an image forming system pertaining to the invention. The image forming system is provided with a high-speed LAN (Local Area Network) with a general communications protocol. Client terminals 400 and 402 for inputting electronic data (printing data) described by page description language (PDL) are connected to the high-speed LAN. The client terminals 400 and 402 are computers that can execute various application programs under different operating systems (OS). A scanner device 410 that reads an image on a document and outputs the image data thereof is also connected to the high-speed LAN.

DFE devices 500, 503, 504, 506 and 508, BEP (Back End Processor) devices 600, 603 and 604 serving as image formation assistance devices of the present invention whose details will be described later, and a CTP device 702 that creates directly printing plate with electronic data are connected to the high-speed LAN.

Printing is effected in a press device 710 using the printing plate created by the CTP device 702. Also, the BEP device 600 is connected in parallel (to the high-speed LAN) to the CTP device 702. A high-speed printer 746 that is the same as image forming devices 11 is connected to the BEP device 600.

Also, an output device 730, high-speed printers 740 and 742 of the same configuration, and a CTP device 700 are connected to the output side of the BEP device 604 connected to the high-speed LAN. Print output is effected from the output device 730 and the high-speed printers 740 and 742, and a printing plate is created in the CTP device 700. Also, the DFE device 503 is connected to printer proofers 720 and 722 of the same configuration via the BEP device 603. The printer proofers 720 and 722 are for output verification for printing, and there are cases where they function as an image forming device example.

Also, the DFE device 504 is connected to a high-speed printer 744, and the DFE device 504 and the high-speed printer 744 serve as a section that handles on-demand printing. The DFE device 506 is connected to an output device 732, and the DFE device 508 is connected to a large output device 750. The configuration having the DFE device 506 and the output device 732, and the configuration having the DFE device 508 and the large output device 750, are the same as the configuration of a conventional image forming device.

The image forming system of the present embodiment has a configuration where devices including CTP and POD (Print On Demand) functions can be mixed in the same system. This is because the BEP devices pertaining to the present invention have the function of various processing data which, after printing data from the client has been converted (RIP processing) to raster data.

Configuration Example

In the image forming system according to the above-described configuration, in order to facilitate description in regard to the embodiment of the invention, representative examples of a configuration where printing is done by creating a printing plate and a configuration where printing is done without creating a printing plate will be described as an embodiment. Namely, description will be given in regard to a configuration A, where an image is formed using the client terminal 400, the DFE device 500, the CTP device 702 and the press device 710, and a configuration B, where an image is formed using the client terminal 400, the DFE device 500, the BEP device 600 and the high-speed printer 746 (image forming device 11).

The DFE device 500 has the function of converting (RIP processing) data from the client terminal 400 into raster data and compressing the raster image after that conversion, but in the present embodiment, the DFE device 500 does not require a printer controller function fulfilling a printing control function dependent on the image forming device 11. Namely, it suffices for the DFE device 500 to have a configuration mainly including only the function of RIP processing.

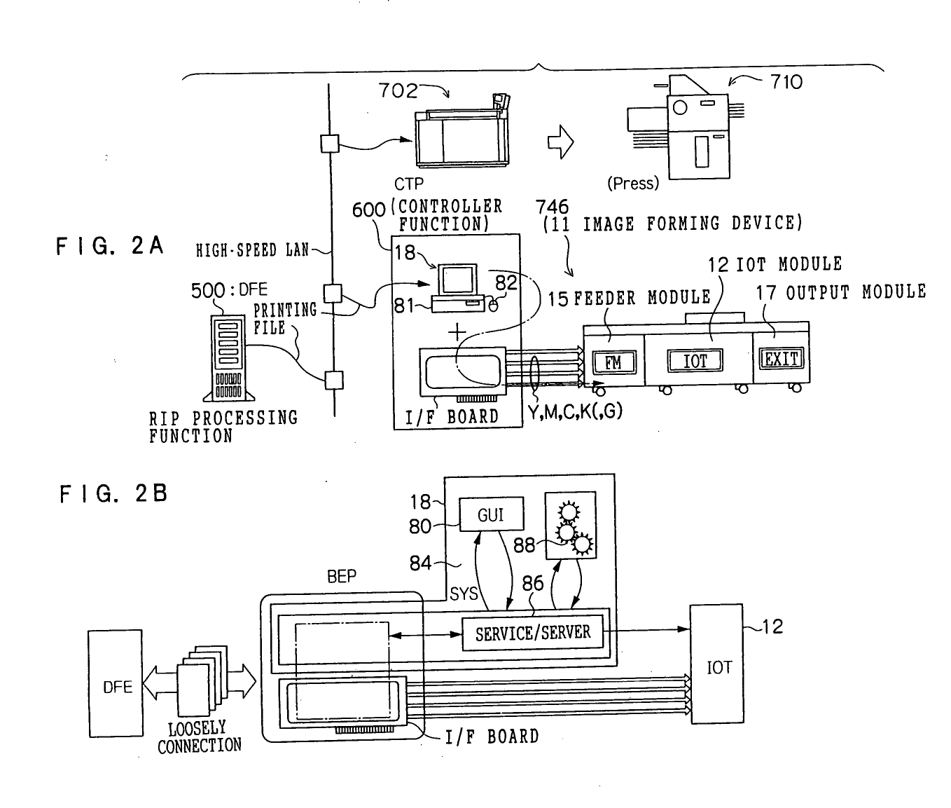

FIGS. 2A and 2B are diagrams showing an embodiment of the image forming system pertaining to the invention. Namely, the configuration A, where an image instructed by the client terminal 400 to be printed is RIP processed by the DFE device 500 and printed by the press device 710 after the printing plate is created by the CTP device 702, and the configuration B, where the RIP processed image is printed by the high-speed printer 746 (image forming device 11) via the BEP device 600, will be described as an embodiment of the image forming system pertaining to the invention. FIG. 2A shows the outline of a system configuration having the configuration A and the configuration B in the present embodiment, and FIG. 2B shows a connection example according to the configuration B.

Configuration A

The configuration A configures a system having the CTP device 702 that creates the printing plate, the DFE device 500 that outputs printing data to the CTP device 702 and instructs the CTP device 702 to make the printing plate, and the press device 710 that conducts printing using the printing plate created by the CTP device 702.

Because the printing conducted in the configuration A is the same as conventional printing, detailed description thereof will be omitted, but the DFE device 500 has the function of converting (RIP processing) data from the client terminal 400 to raster data by ROP (Raster Operation) processing by a front engine and a front end processor (FEP), and compressing the raster image after the conversion. The DFE device 500 mainly executes only RIP processing in order to create the printing plate. The printing plate is created by the CTP device 702 with the raster data of the raster image (compressed), which has been RIP processed. The image is pressed on a recording medium by the press device 710 using the printing plate created by the CTP device 702, and printing is effected.

A case is described where, in the above configuration A, the CTP device 702 is connected to the high-speed LAN and the printing plate is created with the printing data from the DFE device 500, but the CTP device 702 may be connected via the BEP device 600 (configuration of BEP device 604 and CTP device 700 of FIG. 1). In this case, as will be described with the configuration B below, processing dependent on downstream devices such as the image forming device 11 is conducted in the BEP device 600 with the printing data from the DFE device 500 and data is outputted. When the CTP device 700 is used as this downstream device, the BEP device 600 conducts processing dependent on the CTP device 700 and outputs data.

Configuration B

The configuration B configures a system having the image forming device 11, the DFE device 500 that delivers printing data to the image forming device 11 and instructs printing, and the BEP device 600 that is disposed between the image forming device 11 and the DFE device 500.

The image forming device 11 is provided with an IOT module 12, a feeder module (FM) 15, an output module 17, and a user interface device 18 such as a personal computer (PC). The feeder module 15 may also have a multistage configuration. Also, a coupler module that intercouples the modules may also be disposed as needed. Also, a finisher module (post-processing device) may also be connected to the rear stage of the output module 17. Examples of the finisher module include a module provided with a stapler that stacks sheets of paper and staples them at one or more places, and a module provided with a punching mechanism that punches punch-holes.

The DFE device 500 has the function of converting (RIP processing) the data from the client terminal 400 into raster data and compressing the raster image after the conversion, and mainly conducts RIP processing. The data is processed by the BEP device 600 and outputted to the image forming device 11.

The BEP device 600 includes the function of controlling processing dependent on the image forming device 11, but this control function may also be instructed by the user interface device 18 or be preset. In the case where the control function is instructed by the user interface device 18, the user interface device 18 may be configured to include an input device such as a keyboard and/or a GUI (Graphic User Interface) function for presenting an image to the user and receiving instruction input, so as to instruct processing dependent on the image forming device 11.

The BEP device 600 uses RIP processed data retained in the DFE device, whereby efficient high-speed output is enabled. Namely, the BEP device 600 generates a command code on the basis of printing control information received from the DFE device 500 and controls the processing timing of each part in the image forming device 11 in accordance with engine characteristics. Also, the BEP device 600 completes spool processing in conformity with engine characteristics of, for example, the IOT module 12, the feeder module 15, the output module 17, and delivers image data to the IOT module 12.

For example, data including a raster base image that has been RIP processed are sent from the DFE device 500 to the BEP device 600. As this data, compressed raster base image file data of a format such as the TIFF (Tagged Image File Format), and printing control information such as the number of print copies, whether the sheets are to be printed on both sides or one side, whether color or black-and-white printing is to be conducted, synthesized printing, whether or not the copies are to be sorted, and whether or not the copies are to be stapled, are included. Printing control information other than the raster base image file data of TIFF format is described in JDF (Job Definition Format) based syntax such as XML, and is sent from the DFE device 500 to the BEP device 600 as a job ticket. The JDF is sent to each process (e.g., plate-making process, printing process, folding/cutting process, etc.) and used in each process, and content necessary for the job at each process is described in the JDF. For example, the printing matter specifications (configuration, paper quality, size, number, etc.), the equipment used in the plate-making process, the deadline of the plate-making process, the printing machine and the ink used in the printing process, the equipment used in the folding/cutting, its dead line, the delivery destination and deadline, the surface-positioning specifications in the plate-making process, the RIP processing sequence in the plate-making process, the output device setting in the plate-making process, the printing machine setting in the plate-making process, the folder setting in the folding/cutting, the cutter sequence and the binding sequence are described.

Processing that is related to RIP processing, such as page rotation, allocation to one sheet (N-UP), repeat processing, paper size matching, CMS (Color Management System) that corrects difference between devices, resolution conversion, contrast adjustment, and compression ratio designation (low/middle/high), is processed by the DFE device 500, and the BEP device 600 is not notified of that control command (non-notification).

Also, regarding collation, two-sided printing, alignment processing that has a relation to the paper tray or a finisher device such as a stamp, punch or stapler device, discharge surface (vertical) matching, calibration processing such as gray balance and color shift correction, screen designation processing, etc., having a strong relation to the processing features of the image forming device 11 (IOT-dependent processing), those control commands go through the DFE device 500 and are processed in the BEP device 600.

In this manner, the DFE device of the present embodiment unilaterally transfers one job to the BEP device in the order in which it is RIP processed without being dependent on the engine characteristics, and page redisposition for printing is done at the BEP device.

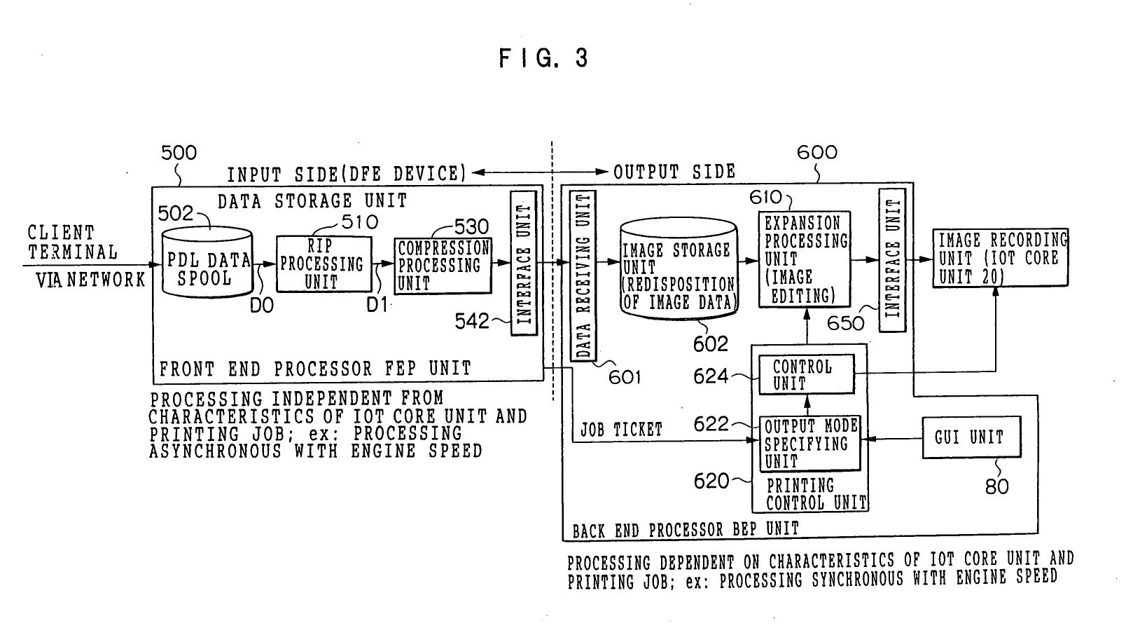

FIG. 3 is a conceptual block diagram showing the flow of data when the BEP device 600 is intervened between the DFE device 500 and the image forming device 11.

The DFE device 500 is provided with a data storage unit 502 that receives printing data (called PDL data below) described by PDL from the client terminal 400 and temporarily and sequentially stores the PDL data, a RIP processing unit 510 that reads from the data storage unit 502 and interprets the PDL data and generates (rasterizes) page unit-image data (raster data), and a compression processing unit 530 that compresses, in accordance with a predetermined format, the image data generated by the RIP processing unit 510. An interface unit 542 is disposed at the latter stage of the compression processing unit 530. Because the RIP processing unit 510 develops the PDL data and generates image data, a decomposer, so-called a RIP engine, functioning as an imager and a PDL analyzing unit is incorporated in the RIP processing unit 510. The compression processing unit 530 compresses the image data from the RIP 510 and instantaneously transfers the compressed image data to the BEP device 600.

The BEP device 600 is provided with an image storage unit 602 that receives and retains the compressed image data processed without relation to the processing characteristics of the print engine 30 and the printing job (e.g., processed asynchronously with the processing speed of the print engine 30) at the DFE device 500, and an expansion processing unit 610 that reads the compressed image data from the image storage unit 602, reads the compressed image data of the DFE device 500, conducts expansion processing corresponding to the compression processing of the compression processing unit 530 of the DFE device 500, and sends the expanded image data to the ITO core unit 20. The expansion processing unit 610 has image processing functions such as image rotation, adjustment of the image position on the paper, or enlargement or reduction, or electronic cutting with respect to the image data read and expanded from the image storage unit 602. A data receiving unit 601 is disposed at the front stage of the image storage unit 602, and an interface unit 650 at output-side is disposed at the rear stage of the expansion processing unit 610.

Also, the BEP device 600 is provided with a printing control unit 620 that is dependent on the processing capability of the IOT core unit 20 and functions as a printer controller which controls each unit of the BEP device 600 and the IOT core unit 20. The printing control unit 620 is provided with an output mode specifying unit 622 that interprets (decodes) the job ticket from the DFE device 500 or receives a user instruction via the GUI unit 80, and specifies an output mode (image position in page, page discharge order, orientation, etc.) in accordance with the processing characteristics of the print engine 30, the fixing unit 70 or the finisher. The printing control unit 620 is also provided with a control unit 624, which controls each of sections such as the print engine 30, the fixing unit 70, the finisher so as to output printing matter in the specified mode. The output mode specifying unit 622 has a function as an output mode information acquisition unit that receives information relating to the output mode that the client desires, and receives information relating to the output mode by acquiring information described in the job ticket and printing control information included in the TIFF format image file data.

Thus, in the DFE device 500, the image data rasterized (draw-deployed) from the page description language by the RIP processing unit 510 are transferred to the BEP device 600 in page order. The BEP device 600 accumulates, in the image storage unit 602 functioning as a buffer, the image data transferred from the DFE device 500. The expansion processing unit 610 reads and expands the compressed data which is from the image storage unit 602, assembles page data in accordance with the printing job designated from the client terminal or the DFE device 500 (page data redisposition, electronic cutting, etc.), and prepares transfer to the designated print engine. Then, the BEP device 600, while exchanges control commands synchronously with the processing speed of the print engine 30, sends, in a predetermined order and to the IOT core unit 20, the page data at a speed maximizing engine productivity.

In this manner, the DFE device 500 may unilaterally transfer one job to the BEP device 600 in the RIP processed order without being dependent on the engine characteristics. Additionally, the BEP device 600 handles processing dependent on the print engine 30 and printing jobs such as page redisposition for printing.

In the present configuration, processing related to RIP processing is conducted by the DFE device, but when redoing of the RIP processing is necessary, the data retained in the image storage unit 602 can be reused without requesting RIP processing again from the DFE device 500 (independently of the DFE device 500). Thus, further RIP processing by the DFE device 500 becomes unnecessary. Also, processing dependent on the processing characteristics of the output side can be done by the BEP device 600 which has the capability applying to the processing characteristics of the output side such as the print engine, and is connected to the print engine 30 and the like.

For example, in a case where the image data is to be outputted in an output mode that the client desires, as reprocessing that has a relation to RIP processing, as an example where processing dependent on the processing characteristics of the output side is necessary, there are page allocation to one sheet of paper (N-UP), repeat processing, paper size matching, CMS (Color Management System) that corrects the difference between devices, resolution conversion, contrast adjustment, and compression ratio designation (low/middle/high).

Also, as an example of a case where processing (dependent processing that has a strong relation to the processing characteristics of the output side) dependent on the processing characteristics of the image forming device 11 (e.g., print engine) that is the output side is necessary, there are image rotation, collation, two-sided printing, alignment processing (shift: image shift) that has a relation to the paper tray or a finisher device such as a stamp, punch or stapler, discharge surface (vertical) matching, calibration processing such as gray balance and color shift correction, and screen designation processing.

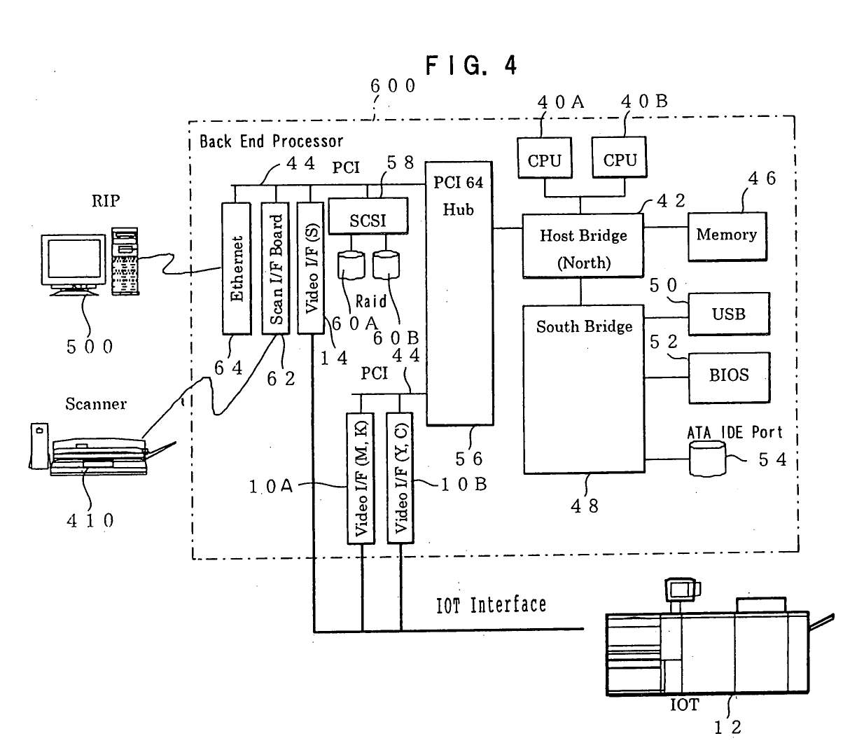

Incidentally, there are cases where the image data created for the CTP device 702 is high-resolution low-gradation image data (e.g., 1 bit, 2400 dpi) but the image data processable by the image forming device 11 is low-resolution high-gradation image data (e.g., 8 bit, 600 dpi). Thus, the BEP device 600 pertaining to the present embodiment includes a gradation conversion function for converting image data created for CTP to image data processable by the image forming device 11. Here, the detailed configuration of the BEP device 600 based on the gradation conversion function will be described. FIG. 4 is a block diagram showing the detailed configuration of the BEP device 600.

In the present embodiment, the BEP device 600 is configured by a computer provided with two CPUs 40A and 40B called dual CPUs. The two CPUs 40A and 40B are connected to a host bridge 42. A PCI (Peripheral Components Interconnect) bus 44 and a memory 46 are connected to the host bridge 42. Data control between the CPUs 40A and 40B and the PCI 44 is conducted by the host bridge 42.

Similar to the host bridge, a south bridge 48 that controls information circulation is connected to the host bridge 42. A USB (Universal Serial Bus) 50 serving as a data transfer path connecting peripheral devices, a BIOS (Basic Input/Output System) 52 having a program group controlling the peripheral devices, and an ATA IDE port 54 for connecting program-use hard disk are connected to the host bridge 48.

The host bridge 42 is connected to a PCI hub (PCI 64 hub) 56 serving as an integrated device that integrates the PCI bus 44. Namely, the PCI bus 44 is plurally connected to the PCI hub 56, so that plural devices can be connected to the PCI bus 44.

Two hard disks 60A and 60B for storing image data are connected to the PCI bus 44 via an SCSI 58 (Small Computer System Interface) for connecting the peripheral devices. By alternately using the two hard disks, seemingly double speed image data reading and writing is possible. Namely, they configure RAIDs (Redundant Arrays of Inexpensive Disks) that collectively manage plural hard disks.

A scanner 410 is connected to the PCI bus 44 via a scan interface (I/F) board 62, and the DFE device (RIP) 500 is connected to the PCI bus 44 via an Ethernet® 64. Namely, the Ethernet® 64 corresponds to the aforementioned interface unit 542 (see FIG. 3).

Moreover, video interfaces (video I/F) 10A, 10B and 14 corresponding to the aforementioned interface unit 650 (see FIG. 3) are connected to the PCI bus 44. The video interface (video I/F (M, K)) 10A is an interface for transfer of image data for magenta (M) and black (K), and the video interface (video I/F (Y, C)) 10B is an interface for image data for yellow (Y) and cyan (C). Also, the video interface (video I/F (S)) 14 is a supplemental interface disposed for image data for special colors (e.g., for additional colors other than Y, M, C and K)

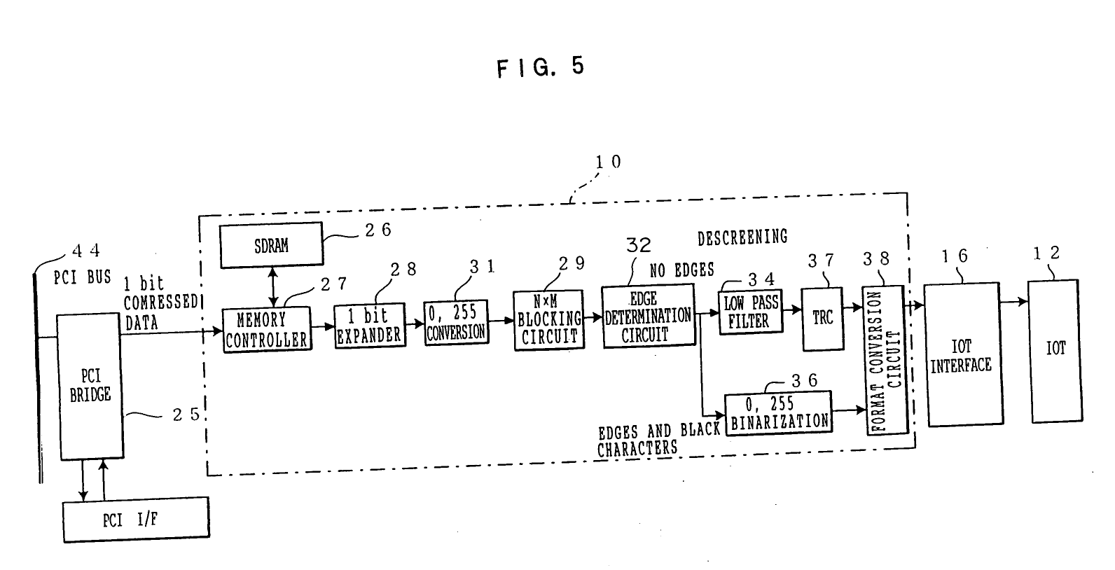

FIG. 5 is a block diagram showing the detailed configuration of the video interfaces 10A and 10B. In FIG. 5, the video interfaces 10A and 10B will be described as a video interface 10 because they have the same configuration.

The video interface 10 is connected via a PCI bridge 25 for relaying data.

The video interface 10 includes a memory controller 27, an SDRAM 26, a 1-bit expander 28, a 0, 255 conversion circuit 31, an N×M blocking circuit 29, an edge determination circuit 32, a low pass filter 34, a binarization circuit 36, a TRC circuit 37 and a format conversion circuit 38, and is connected to the IOT module 12 via the IOT interface 16.

The PCI bridge 25 is connected to the memory controller 27 from/to which the SDRAM 26 is connected, and the reading/writing of image data to the SDRAM 26 is controlled by the control of the memory controller 27.

Image data read from the SDRAM 26 is outputted to the 1 bit expander 28 connected to the memory controller 27, and Jpeg or the like compressed data is expanded by the 1-bit expander 28. Image data having 1 bit gradation and a resolution of 2400 dpi is inputted to the 1-bit expander 28.

As for the image data expanded by the 1 bit expander 28, 1 bit image data is converted to multiple values of 0, 255 by the 0, 255 conversion circuit 31. At this time, the conversion is conducted by replacing 1 bit off with 0 and on with 255. Then, the image data is inputted to the N×M blocking circuit 29, for example, 5×5 blocks are extracted, edge is determined by the edge determination circuit 32, and in accordance with the determination result, descreening processing (in the present embodiment, the conversion of 1 bit to 8 bit) by the low pass filter 34 or binarization processing (processing prohibiting descreening processing) by the binarization circuit 36 is conducted. Namely, descreening processing by the low pass filter is conducted is regard to portions other than the edges, and binarization processing by the binarization circuit 36 is conducted in regard to the edge portions.

Here, as for the image data to which descreening processing by the low pass filter 34 has been conducted, the gradation characteristics of Y, M, C and K data are corrected by the TRC circuit 37 per color, per recording medium and per environmental condition.

The edge determination circuit 32 corresponds to a line image determination unit of the invention, and the 0, 255 conversion circuit 31, the low pass filter 34 and the binarization circuit 36 correspond to a conversion unit of the present invention. Additionally, the 0, 255 conversion circuit 31 and the low pass filter 34 correspond to a first gradation conversion unit of the invention, and the 0, 255 conversion circuit 31 and the binarization circuit 36 correspond to a second gradation conversion unit of the invention.

Then, the image data processed by the TRC circuit 37 or the binarization circuit 36 is outputted to the format conversion circuit 38, and outputted to the IOT module 12 via the IOT interface 16 after format conversion (e.g., processing that synthesizes the binarized image data with the descreened image data, processing that converts the resolution from 2400 dpi to 600 dpi, etc.) in accordance with the IOT module 12 has been conducted.

Namely, the video interface 10 sequentially descreens image data per N×M block with the low pass filter 34, whereby it converts 1 bit data of 2400 dpi to 8 bit data of 600 dpi. Also, at this time, the video interface 10 processes in regard to edge portions in accordance with the determination result of the edge determination circuit to prohibit descreening processing and retain the binary (0 or 255). Such processing is conducted while shifting 1 pixel per N×M block, the image data for which descreening processing has been conducted and the image data for which binarization processing has been conducted are synthesized, and high-resolution low-gradation image data is converted to low-resolution high-gradation image data that can be processed by the IOT module 12.

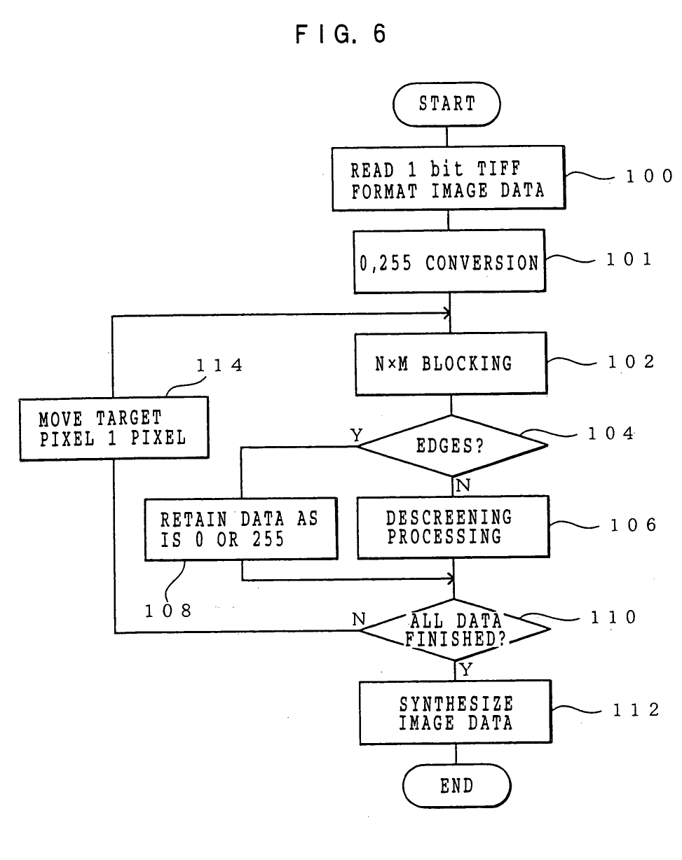

Next, an example of the flow of processing conducted by the video interface 10 of the BEP device 600 configured as described above will be described. FIG. 6 is a flow chart showing an example of the flow of processing conducted by the video interface 10.

First, in step 100, 1 bit TIFF format image data is read. Namely, image data accumulated in the SDRAM 26 is read by the memory controller 27 and expanded by the 1 bit expander 28. The processing moves to step 101, where conversion to multiple values, so that 1 bit on becomes 255 and off becomes 0, is performed by the 0, 255 conversion circuit 31.

Next, in step 102, the read 1 bit TIFF format image data is read per N×M block by the N×M blocking circuit 29, the processing moves to step 104, and it is determined by the edge determination circuit 32 whether or not there are edges. This determination may be made on the basis of an average density of the N×M blocks and a predetermined threshold with respect to this (e.g., determination that there is an edge when the average density is equal to or greater than the threshold), or may be made so that it is determined there is an edge when an image where pixels in the same column number in the N×M pixels (e.g., 0, 255) are continuous in a CMYK 1 bit (data converted by the 0, 255 conversion circuit) image. Namely, the edge determination circuit 32 determines whether or not there are characters or line images by determining the edges.

Here, when the determination of step 104 is negative, i.e., in the case of an image other than characters or line images, such as a photograph, the processing moves to step 106, where descreening processing by the low pass filter 34 is conducted, and the processing moves to step 110. Thus, the image data is converted from a low gradation of 1 bit to a high gradation of 8 bit. At this time, the gradation characteristics of the image data for which descreening processing by the low pass filter 34 has been conducted are corrected by the TRC circuit 37 per color, per recording medium and per environmental condition.

When the determination in step 104 is affirmative, i.e., in the case of characters and line images, the processing moves to step 108.

In step 108, the descreening processing by the low pass filter 34 is prohibited, and in regard to these portions, the data is maintained by the binarization circuit 36 as is 0 or 255, and the processing moves to step 110. Namely, characters and lines images can be prevented from becoming ambiguous (unclear) by the descreening processing by the low pass filter 34. In the present embodiment, the invention is configured so that, in step 108, the descreening processing by the low pass filter 34 is prohibited and binarization processing is conducted, but the invention may also be configured so that, after the binarization processing, descreening processing is conducted using a low pass filter whose filter factor is set so that it becomes a weaker low pass filter than the low pass filter used in the descreening processing of step 106. Namely, smooth characters and line images can be obtained by conducting descreening processing to the extent that it suppresses indentations in the characters and line images. Also, the low pass filter whose index is set so that it becomes a weaker low pass filter than the low pass filter 34 in this case corresponds to the second gradation conversion unit of the invention.

In step 110, it is determined whether or not the aforementioned processing has ended in regard to all image data, and when the determination is negative, the processing moves to step 114, where a target pixel is moved 1 pixel, the processing returns to the aforementioned step 102, the aforementioned processing is repeated until the determination of step 110 is affirmative, and the processing moves to step 112 when the determination of step 110 is affirmative.

In step 112, the image data retained by the binarization processing is synthesized, by the format conversion circuit 38, with the image data descreened by the low pass filter 34, and the series of processing ends. When the synthesis of the image data is conducted, the image data are simultaneously converted by the format conversion circuit 38 to a resolution corresponding to the IOT module 12. In the present embodiment, it is converted from 2400 dpi to 600 dpi. Thus, it becomes possible to use image data created for CTP in the image forming device 11, and CTP and on-demand printing can be shared.

In the present embodiment, the invention is configured so that, when the processing of steps 102 to 108 has ended in regard to all pixels, the image data retained by the binarization processing is synthesized with the image data descreened by the low pass filter 34, but the invention may also be configured so that the image data are sequentially synthesized by conducting the processing of steps 102 to 108 in regard to each pixel.

In the present embodiment, the invention is configured so that, in details, at the time of resolution and gradation conversion, a tag representing the result of the edge determination of step 104 is generated and binarization processing and descreening processing by the low pass filter 34 are separated in accordance with the tag. For example, tags of 0 and 1 are used, with 0 representing the fact that there is no edge and 1 representing the fact that there is edge, and when the tag is 0, descreening processing by the low pass filter 34 is conducted, and when the tag is 1, binarization processing by the binarization circuit 36 is conducted.

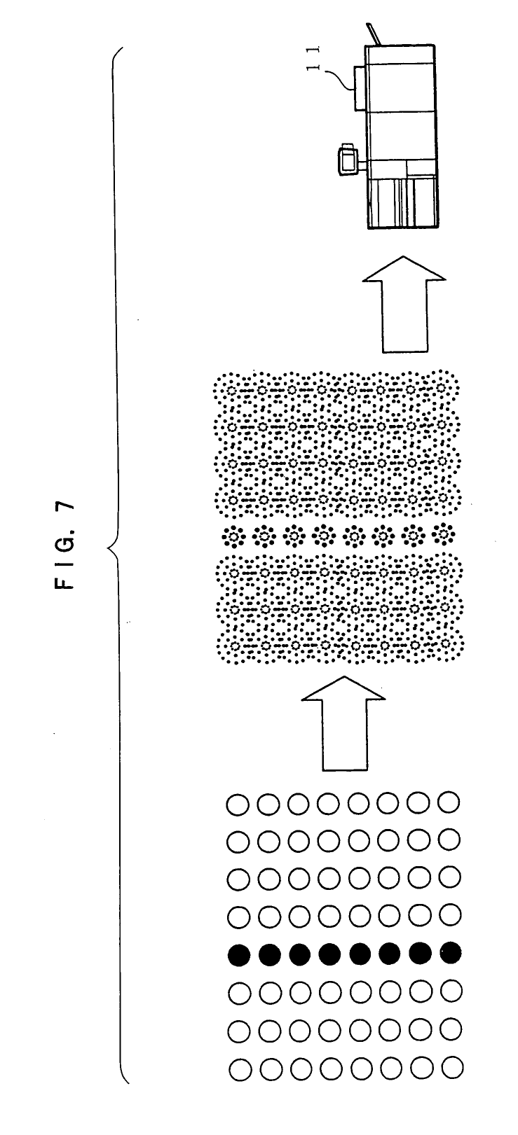

Namely, when all images obtained from the 1 bit TIFF format are descreened by the low pass filter 34, they can be converted to multiple value images and outputted to the image forming device 11 as shown in FIG. 7, but characters and line images end up becoming submerged or faint. Thus, in the video interface 10 of the BEP device of the present embodiment, as previously mentioned, without conducting descreening processing by the low pass filter of all from the 1 bit information, the characters and line images retain 0, 255 information and descreening processing by the low pass filter of only the intermediate tones is conducted. Thus, deterioration of characters and line images resulting from conducted resolution and gradation conversion can be prevented. It should be noted that the left side of FIG. 7 shows one example of an image expressed by 1 bit, and the middle shows an example of an image when the 1 bit of the left side is gradation-converted to 8 bit.

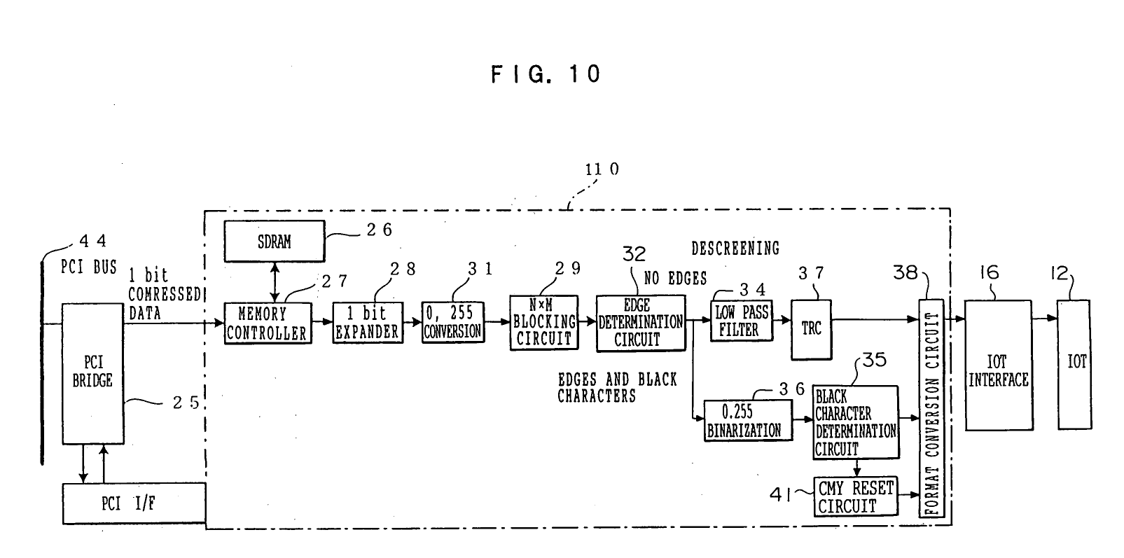

Next, a case using a video interface 110 shown in FIG. 10 instead of the video interface 10 (video interfaces 10A and 10B) shown in FIG. 5 will be described. The same reference numerals will be given to elements that are the same as those of the video interface 10 shown in FIG. 5, and detailed description thereof will be omitted.

The video interface 110 includes a memory controller 27, an SDRAM 26, a 1-bit expander 28, a 0, 255 conversion circuit 31, an N×M blocking circuit 29, an edge determination circuit 32, a low pass filter 34, a binarization circuit 36, a black character determination circuit 35, a CMY reset circuit 41, a TRC circuit 37 and a format conversion circuit 38, and is connected to the IOT module 12 via the IOT interface 16.

Image data binarized by the binarization circuit 36 is determined by the black character determination circuit 35 whether or not it is black character, and in regard to a portion determined to be black character, the data of the colored colors of C, M and Y are reset to 0 by the CMY reset circuit 41 (C=M=Y=0).

The black character determination circuit 35 corresponds to a determination unit of the invention, and the CMY reset circuit 41 corresponds to an image processing unit and a reset unit of the invention.

Then, the image data processed by the TRC circuit 37, the image data processed by the binarization circuit 36, or the image data whose CMY data has been reset by the CMY circuit 41 is outputted to the format conversion circuit 38, and after format conversion (e.g., processing that synthesizes the descreened image data, the binarized image data and the image data whose CMY has been reset; processing to convert the resolution from 2400 dpi to 600 dpi; etc.) in accordance with the IOT module 12 has been conducted, the image data is outputted to the IOT module 12 via the IOT interface 16.

Moreover, with respect to the binarized image data, because black character is judged and the each data of the colored colors is reset, the colored colors can be prevented from spreading to black character, and the sharpness of the black character can be maintained.

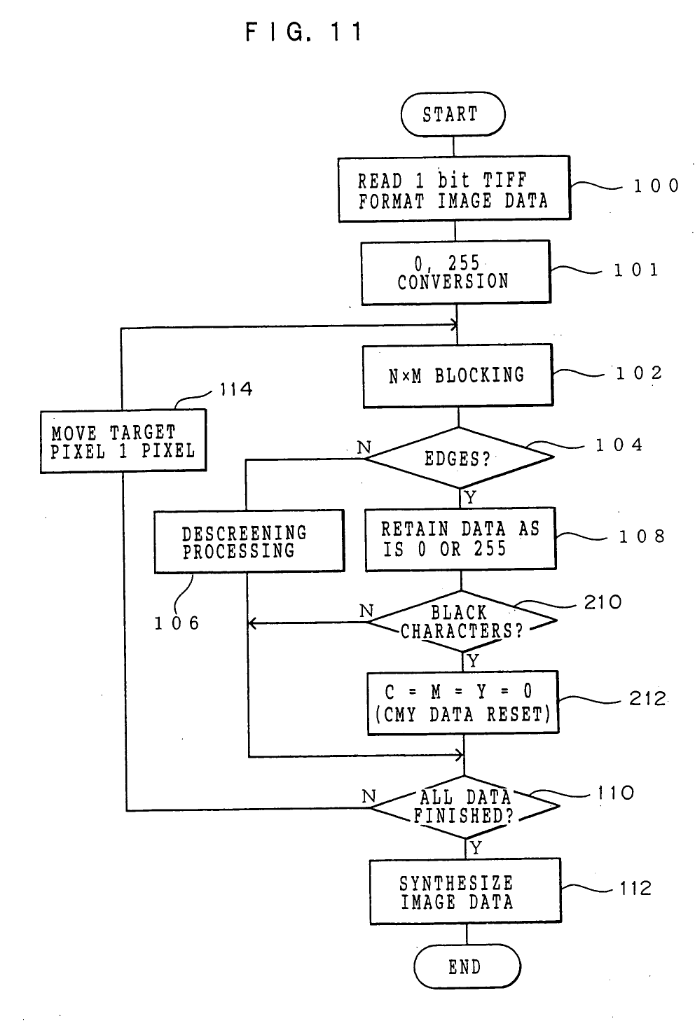

Next, an example of the flow of processing conducted by the video interface 110 of the BEP device 600 configured as described above will be described. FIG. 11 is a flow chart showing an example of the processing conducted by the video interface 110.

In FIG. 1, the same reference numerals will be given to steps that are the same as those in FIG. 6, and detailed description thereof will be omitted.

In step 210, it is determined by the black character determination circuit 35 whether or not there is black character. This determination is done by referencing the C, M and Y data and determining whether or not any of the colors is on (255). When the determination is negative, the processing moves to step 110, and when the determination is affirmative, the processing moves to step 212.

The black character determination by the black character determination circuit 35 may be done so that, after the edge determination is conducted as in the edge determination of step 104, a case where there is only black (K) edge and image data is determined to be black character, or so that the image data of each color of YMCK is converted to Lab color space data and it is determined whether or not the converted Lab space image data is within a predetermined wind comparator. For example, it is determined to be black character in a case where the Lab converted image data falls within a wind comparator where a* and b* are within ±20 and L* is equal to or less than 10.

In step 212, the image data is converted to C=M=Y=0 (CMY reset) by the CMY reset circuit 41, and the processing moves to step 110. Namely, because the color data of the portion of the black character is reset, low-gradation image data can be converted to high-gradation image data while maintaining the sharpness of the black character.

In step 112, the image data descreened by the low pass filter 34, the image data retained by the binarization processing and the CMY reset image data are synthesized by the format conversion circuit 38, and the series of processing ends.

A case is described where, when the processing of steps 102 to 212 has ended in regard to all pixels, the image data descreened by the low pass filter 34, the image data retained by the binarization processing and the CMY reset image data are synthesized, but the invention may also be configured so that the image data is sequentially synthesized by conducted to the processing of steps 102 to 212 in regard to each pixel.

Moreover, similar to the above edge determination, a tag representing the result of the black character determination of step 210 is generated and CMY reset is conducted in accordance with the tag. For example, tags of 0 and 1 are used as tags representing the results of the black character determination, with 0 representing the fact that there is no black character and 1 representing the fact that there is black character, and when the tag is 0, the binarized value is used as it is, and when the tag is 1, reset is conducted in regard to the CMY data.

Namely, when the colored colors of CMY are used as they are in regard to character/line image detected by the edge determination, the potential for the colored colors to spread (black becomes mixed with other colors) to the black character (including black line image) can be prevented by reset the CMY data in regard to the black character portion, and the sharpness of the black character can be maintained.

Next, a modified example of the present embodiment will be described.

In the above embodiment, the invention is configured so that the CMY data are reset when black character is judged by the black character determination circuit 35, but the modified example is one where CMY reset is prohibited in regard to process black (case where the CMY data are equal) even when black character determination is made.

The configuration of the BEP device 600 is basically the same except that the black character determination circuit 35 of the video interface 10 conducts, in addition to the black character determination, determination of whether or not it is process black, and prohibits CMY reset when it is determined that it is process black. Namely, the black character determination circuit corresponds to a determination unit and a prohibition unit of the invention. The determination of whether or not it is process black is done by determining whether or not C=M=Y.

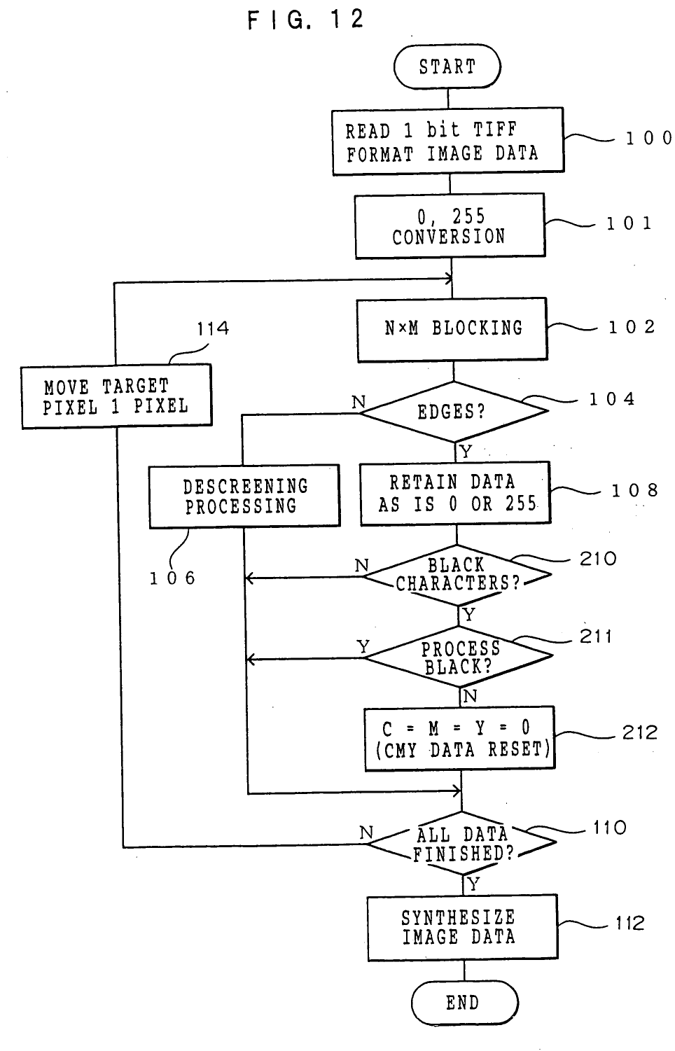

FIG. 12 is a flow chart showing the flow of processing conducted by the video interface of the modified example. The only difference between the processing of the modified example and the processing of the above embodiment is that, in the modified example, step 211 is added between steps 210 and 212 with respect to the processing (flow chart of FIG. 11) conducted in the above embodiment. Because the remaining processing is the same, the same reference numerals will be given in FIG. 12 to steps that are the same as those in FIG. 11, and detailed description thereof will be omitted.

Namely, when edge is determined by the edge determination circuit 32 and binarization processing is conducted (when the processing of step 108 is conducted), the processing moves to steps 210 and 211.

In step 211, it is determined whether or not it is process black. When the determination is affirmative, the processing moves to step 110 without conducting CMY reset by the CMY reset circuit 41, and when the determination of step 211 is negative, the processing moves to step 212, where CMY reset by the CMY reset circuit 41 is conducted.

Namely, when the black character-determined portion is process black, there is the potential that the CMY data are being intentionally used, so CMY reset is prohibited. Thus, intentional process black can be reproduced. For example, because process black is sometimes used in images such as a painting in black and white (Chinese ink), the process black is gradation-converted without conducting CMY reset as previously mentioned, and intentional process black can be reproduced as an image after gradation conversion.

Then, in step 110, similar to the above embodiment, it is determined whether or not the aforementioned processing has ended in regard to all image data, and when the determination is negative, the processing moves to step 114, a target pixel is moved 1 pixel, the processing returns to the aforementioned step 102, the aforementioned processing is repeated until the determination of step 110 is affirmative, and the processing moves to step 112 when the determination of step 110 is affirmative.

In step 112, the image data descreened by the low pass filter 34, the image data retained by the binarization processing, the CMY reset image data and the binarized process black image data are synthesized by the format conversion circuit 38, and the series of processing ends. When the synthesis of the image data is conducted, the image data is simultaneously converted by the format conversion circuit 38 to a resolution corresponding to the IOT module 12. In the present embodiment, the image data are converted from 2400 dpi to 600 dpi. Thus, it becomes possible to use image data created for CTP in the image forming device 11, and CTP and on-demand printing can be shared.

In the first aspect of the invention, the device may further includes an image format converter that converts an image format of the image data in accordance with an image forming device which prints out the image data.

Further, the gradation converter may be configured by a low pass filter. Namely, it becomes possible to conduct gradation processing using a low pass filter used in descreening.

Also, the gradation converter may be configured by a first gradation converter that conducts the gradation conversion processing that converts gradation of the image data from a low gradation to a high gradation when the determination result of the determination unit does not indicate a character/line image portion, and a second gradation converter that conducts the gradation conversion processing, which is different from that of the first gradation converter, when the determination result of the determination unit indicates the character/line portion. For example, when converting gradation from 1 bit to 8 bit, descreening is conducted using the low pass filter as the first gradation converter, and a binarization unit that conducts gradation conversion of 0, 255 binarization may be applied as the second gradation converter. Namely, the deterioration of the character and the line image resulting from the gradation conversion can be prevented by conducting gradation conversion by binarization in regard to the character/line image portion.

Further, the device may further includes a composition unit that composes the image portion converted by the first gradation converter and the image portion converted by the second gradation converter.

Moreover, the first gradation converter and the second gradation converter may be configured by low pass filters, and the respective filter factors may be set so that the second gradation converter becomes a low pass filter that is weaker in comparison to the first gradation converter. In other words, descreening may be conducted with a weak low pass filter in regard to the character/line image portion, so that by using, for the character/line image portion, a low pass filter that is weaker than the low pass filter used for a portion other than the character/line image portion, the deterioration of the character/line image portion can be prevented and indentation in character/line image portion can be prevented.

The memory retains binary data as image data created for the printing plate.

In the second aspect of the invention, the method further includes converting an image format of the image data in accordance with an image forming device which prints out the image data.

Further, the converting step may conduct gradation conversion processing using the low pass filter. Namely, it becomes possible to conduct gradation processing using the low pass filter used in descreening.

Also, the conversion step may be configured by a first gradation converting step that conducts the gradation conversion processing that converts gradation of the image data from a low gradation to a high gradation when the determination result of the determination unit does not indicate the character/line image portion, and a second gradation converting step that conducts the gradation conversion processing, which is different from that of the first gradation converting step, when the determination result of the determining step indicates the character/line portion. For example, when converting gradation from 1 bit to 8 bit, descreening using the low pass filter may be conducted as the first converting step, and gradation conversion of 0, 255 binarization may be conducted as the second converting step. Namely, the deterioration of the character and line image resulting from the gradation conversion can be prevented by conducting gradation conversion by binarization in regard to the character/line image portion.

Further, the method may further includes composing the image portion converted in the first gradation conversion processing and the image portion converted in the second gradation conversion processing.

Moreover, the first gradation converting step and the second gradation converting step may conduct the gradation conversion using low pass filters, and the respective filter factors may be set so that the second gradation converting step uses a low pass filter that is weaker in comparison to the first gradation converting step. In other words, descreening may be conducted with a weak low pass filter in regard to the character/line image portion, so that by using, for the character/line image portion, a low pass filter that is weaker than the low pass filter used for a portion other than the character/line image portion, the deterioration of the character/line image portion can be prevented and indentation in the character/line image portion can be prevented.

The image storage step retains binary data as image data created for the printing plate.

In the fourth aspect of the invention, the image processing unit may include a reset unit that resets, on the basis of the determination result of the determination unit, color data other than black data in the image data corresponding to the black character portion. That is, because the color data other than black data in the image data corresponding to the black character portion can be eliminated, the sharpness of the black character after gradiation conversion can be maintained.

Also, the image processing unit may further include a process black determination unit that determines whether or not the image data determined to correspond to the black character portion by the determination unit is image data expressed by color data other than black data (what is called process black), and a prohibition unit that prohibits the reset by the reset unit in regard to a portion which is determined as the image data expressed by the color data by the process black determination unit. Thus, it becomes possible to reproduce process black in regards to image data after gradation conversion, for intentionally usage of process black.

In the fourth aspect of the invention, the device further includes a line image determination unit that determines a character/line image portion in the image data stored in the memory, with the gradation converter conducting gradation conversion processing that converts the image data from low-gradation to high-gradation image data on the basis of the determination of the line image determination unit. Thus, it becomes possible to conduct different gradation conversions between the character and line image portion and a portion other than these, and gradation conversion according to respective attributes can be done. Thus, the deterioration of the characters/line image portion resulting from the gradation conversion can be prevented.

Also, the gradation converter may be configured by the low pass filter. Namely, it becomes possible to conduct gradation processing using the low pass filter used in descreening.

Also, the gradation converter may be configured by a first gradation converter that conducts the gradation conversion processing processing that converts gradation of the image data from a low gradation to a high gradation when the determination result of the determination unit does not indicate the character/line image portion, and a second gradation converter that conducts the gradation conversion processing, which is different from that of the first gradation converter, when the determination result of the determination unit indicates the character/line portion. For example, when converting gradation from 1 bit to 8 bit, conducting descreening using the low pass filter as the first gradation converter, and a binarization unit that conducts gradation conversion of 0, 255 binarization may be applied as the second gradation converter. Namely, the deterioration of the character and line image resulting from the gradation conversion can be prevented by conducting gradation conversion by binarization in regard to the character/line image portion.

Moreover, the first gradation converter and the second gradation converter may be configured by low pass filters, and the respective filter factors may be set so that the second gradation converter is a low pass filter that becomes weaker in comparison to a low pass filter of the first gradation converter. In other words, descreening may be conducted with a weak low pass filter in regard to the character/line image portion, so that by using, for the character/line image portion, a low pass filter that is weaker than the low pass filter used for a portion other than the character/line image portion, the deterioration of the character/line image portion can be prevented and indentation in the character/line image portion can be prevented.

The invention has been described using embodiments, but the technical scope of the invention is not limited to the scope described in the embodiments. Various modifications or improvements can be added to the embodiments as long as they do not deviate from the gist of the invention, and embodiments to which such modifications or improvements have been added are included in the technical scope of the invention.

Also, the above-described embodiments are not intended to limit the invention, and it is not the case that all combinations of features described in the embodiments are necessary for the invention. Aspects of various stages are included in the embodiment, and various aspects can be extracted by appropriately combining the disclosed constituent elements. Even if several constituent elements are deleted from all of the constituent elements described in the embodiments, configurations from which those several constituent elements have been deleted can be extracted as aspects of the invention as long as effects are obtained.

The compression/expansion processing can be made into suitable processing in accordance with the characteristics of the image objects, such as image objects expressed by mainly binary such as a line image and a character (line image character object LW (Line Work)) and image objects expressed in mainly multi-tone such as a background portion and a photograph portion (multi-tone image object CT (Continuous Tone)).

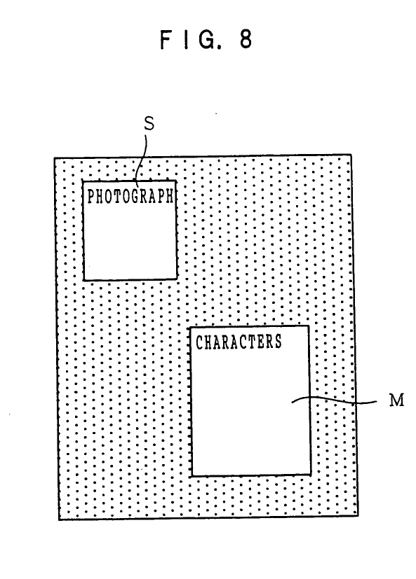

Also, in the present embodiments, the invention is configured so that image data is as N×M block by the N×M blocking circuit 29, edge determination is conducted, and descreening processing is conducted in accordance with the determination result, but the invention may also be configured so that the edge determination is manually instructed (instruction of the coordinate of a portion where descreening processing is prohibited, instruction of descreening processing prohibition region using a GUI, instruction of describing descreening prohibition region in JDF, etc.) using the user interface device 18 of the BEP device 600. For example, as shown in FIG. 8, the invention may be configured so that when a photograph region S and a character region M are understood, the character region M is set to a descreening prohibition region (binarization processing region) by designating the character region M in advance with coordinates or designating the character region M using a GUI or the like.

1. An image formation assistance device that processes image data comprising:
a memory that retains image data created for a printing plate;
a line image determination unit that determines a character/line image portion in the image data stored in the memory; and
a gradation converter that conducts gradation conversion processing that converts gradation of the image data from a low gradation to a high gradation on the basis of a determination result of the line image determination unit.

2. The image formation assistance device of claim 1, further comprising an image format converter that converts an image format of the image data in accordance with an image forming device which prints out the image data.

3. The image formation assistance device of claim 1, wherein the gradation converter comprises a low pass filter.

4. The image formation assistance device of claim 1, wherein the gradation converter comprises
a first gradation converter that conducts a first gradation conversion processing on a portion determined not to be the character/line image portion by the determination unit, and
a second gradation converter that conducts a second gradation conversion processing, which is different from the first gradation conversion processing, on a portion determined to be the character/line image portion by the determination unit.

5. The image formation assistance device of claim 4, further comprising a composition unit that composes the image portion converted by the first gradation converter and the image portion converted by the second gradation converter.

6. The image formation assistance device of claim 4, wherein the first gradation converter and the second gradation converter comprise low pass filters, and respective filter factors are set so that the low pass filter of the second gradation converter is weaker than that of the first gradation converter.

7. The image formation assistance device of claim 1, wherein the memory retains binary image data created for the printing plate.

8. An image formation assistance method that processes image data comprising:
retaining image data created for a printing plate;
determining a character/line image portion in the image data; and
conducting gradation conversion processing that converts gradation of the image data from a low gradation to a high gradation on the basis of a determination result obtained when determining the character/line image portion.

9. The image forming assistance method of claim 8, further comprising converting an image format of the image data in accordance with an image forming device which prints out the image data.

10. The image formation assistance method of claim 8, wherein the gradation conversion is conducted using a low pass filter.

11. The image formation assistance method of claim 8, wherein at conducting gradation conversion processing,
a first gradation conversion processing is conducted on a portion determined not to be the character/line image portion when determining the character/line image portion, and
a second gradation conversion processing, which is different from the first gradation converting processing, is conducted on a portion determined to be the character/line image portion when determining the character/line image portion.

12. The image formation assistance method of claim 11, further comprising composing the image portion converted in the first gradation conversion processing and the image portion converted in the second gradation conversion processing.

13. The image formation assistance method of claim 11, wherein the first gradation conversion processing and the second gradation conversion processing are conducted using low pass filters, and respective filter factors are set so that the low pass filter used when conducting the second gradation conversion processing is weaker than that used when conducting the first gradation conversion processing.

14. The image formation assistance method of claim 8, wherein binary image data created for the printing plate is retained.

15. An image formation assistance system comprising:
an image formation assistance device that processes image data comprising:
a memory that retains image data created for a printing plate;
a line image determination unit that determines a character/line image portion in the image data stored in the memory; and
a gradation converter that conducts gradation conversion processing that converts gradation of the image data from a low gradation to a high gradation on the basis of a determination result of the line image determination unit; and
an image generation device that processes the printing job to generate the image data and outputs the image data to the image formation assistance device.

16. An image formation assistance device that processes image data comprising:
a memory that retains image data created for a printing plate;
a gradation converter that converts gradation of the image data stored in the memory from a low gradation to a high gradation;
a determination unit that determines a black character portion in high-gradation image data obtained by the conversion of the gradation converter; and
an image processing unit that conducts image processing, on the basis of a determination result of the determination unit, on image data corresponding to the black character portion so as to be one color of black.

17. The image formation assistance device of claim 16, wherein the image processing unit includes a reset unit that resets, on the basis of the determination result of the determination unit, color data other than black data in the image data corresponding to the black character portion.

18. The image formation assistance device of claim 17, wherein the image processing unit comprises
a process black determination unit that determines whether or not the image data determined to correspond to the black character portion by the determination unit is image data expressed by color data other than black data, and
a prohibition unit that prohibits the reset by the reset unit in regard to a portion which is determined as the image data expressed by the color data by the process black determination unit.

19. The image formation assistance device of claim 16, further comprising a line image determination unit that determines a character/line image portion in the image data stored in the memory, wherein the gradation converter conducts gradation conversion processing that converts gradation of the image data from a low-gradation to a high-gradation on the basis of a determination result of the line image determination unit.

20. The image formation assistance device of claim 18, wherein determination is made by the process black determination unit base on whether or not ratios of each of the color data are same.
